(19) United States
(12) Patent Application Publication
(10) Pub. No.: US 2018/0225390 A1
(43) Pub. Date: Aug. 9, 2018

(54) SYSTEM AND METHOD FOR PERFORMING DESCRIPTIVE ANALYSIS IN DATA MINING

(71) Applicant: Wipro Limited, Bangalore (IN)

(72) Inventors: Sandipan Bhattacharyya, Kolkata (IN); Soumendu Bhattacharyya, Kolkata (IN); Puneet Kaur, Nagar Mohali (IN)

(21) Appl. No.: 15/463,889

(22) Filed: Mar. 20, 2017

(30) Foreign Application Priority Data
Feb. 3, 2017 (IN) 201741004097

(51) Int. Cl. G06F 17/30; G06F 17/18

(52) U.S. Cl. CPC G06F 17/30979; G06F 17/18

(57) ABSTRACT

This disclosure relates generally to data mining, and more particularly to a system and method for performing descriptive analysis in data mining. In one embodiment, a method is provided for performing a descriptive analysis in data mining. The method comprises receiving one or more data files comprising a plurality of data variables from one or more data sources, determining a set of data variables from the plurality of data variables based on their relevance to the descriptive analysis, identifying at least one of a set of continuous data variables and a set of categorical data variables from the set of data variables, and performing a first descriptive analysis on the set of continuous data variables and a second descriptive analysis on the set of categorical data variables.

### TECHNICAL FIELD

This disclosure relates generally to data mining, and more particularly to system and method for performing descriptive analysis in data mining.

### BACKGROUND

In an increasingly digital world, there is an exponential growth in data volume. Many a times these large and complex data need to be mined so as to uncover hidden patterns and unknown correlations. Thus, data mining is the process of analyzing the data from different dimensions or perspectives, identifying categories and relationships, and summarizing the identified categories and relationships into useful information. As will be appreciated, in a business world, such findings may help identify market trends, customer preferences, and other useful information which in turn may be used to enhance sales, increase revenues, cut on costs, develop effective marketing strategies, identify new business opportunities, deliver better customer service, and so forth. However, data mining involves large and complex data that is difficult to handle. For example, data analysts find it difficult to analyze terabytes of data having thousands of attributes (i.e., fields). The issue is further aggravated as structured and the unstructured data sources have variables in different formats (e.g., numeric, alphanumeric, characters etc.).

An important aspect of data mining is descriptive analysis of raw data. The descriptive analysis involves processing large chunks of raw data to analyze past events and to construct an initial insight on approach for subsequent analysis or processing of data. Additionally, the descriptive analysis analyzes past performance by mining the historical data to determine a success or a failure of processing. The descriptive analysis may be used by for various management reporting (e.g., sales, marketing, operations and finance) for reference. For example, the initial insight provided by the descriptive analysis may help understanding key business challenges, and may facilitate identifying indicators for a solution in a short span of time.

The descriptive analysis typically includes defining, constructing and interpreting visual descriptions of data. Additionally, the descriptive analysis of data may be in the form of various statistical evaluations such as frequency distribution, percentile distribution (e.g., p00, . . . p100), missing value distribution, mean value, median value, standard deviation, outlier analysis, correlation analysis, and so forth. For example, frequency distributions provide an initial organizational information that may be starting point for many other statistical evaluation. Similarly, other visual descriptions may be interpreted using descriptive analysis. However, different types of descriptive analysis require different types of functions for execution, and may therefore be computationally and storage intensive. In other words, these different types of functions would require additional processing for the execution, and additional memory for storage.

### SUMMARY

In one embodiment, a method for performing a descriptive analysis in data mining is disclosed. In one example, the method comprises receiving one or more data files comprising a plurality of data variables from one or more data sources. The method further comprises determining a set of data variables from the plurality of data variables based on their relevance to the descriptive analysis. The method further comprises identifying at least one of a set of continuous data variables and a set of categorical data variables from the set of data variables. The method further comprises performing a first descriptive analysis on the set of continuous data variables and a second descriptive analysis on the set of categorical data variables.

In one embodiment, a system for performing a descriptive analysis in data mining is disclosed. In one example, the system comprises at least one processor and a memory communicatively coupled to the at least one processor. The memory stores processor-executable instructions, which, on execution, cause the processor to receive one or more data files comprising a plurality of data variables from one or more data sources. The processor-executable instructions, on execution, further cause the processor to determine a set of data variables from the plurality of data variables based on their relevance to the descriptive analysis. The processor-executable instructions, on execution, further cause the processor to identify at least one of a set of continuous data variables and a set of categorical data variables from the set of data variables. The processor-executable instructions, on execution, further cause the processor to perform a first descriptive analysis on the set of continuous data variables and a second descriptive analysis on the set of categorical data variables.

In one embodiment, a non-transitory computer-readable medium storing computer-executable instructions for performing a descriptive analysis in data mining is disclosed. In one example, the stored instructions, when executed by a processor, cause the processor to perform operations comprising receiving one or more data files comprising a plurality of data variables from one or more data sources. The operations further comprise determining a set of data variables from the plurality of data variables based on their relevance to the descriptive analysis. The operations further comprise identifying at least one of a set of continuous data variables and a set of categorical data variables from the set of data variables. The operations further comprise performing a first descriptive analysis on the set of continuous data variables and a second descriptive analysis on the set of categorical data variables.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for performing descriptive analysis in data mining in accordance with some embodiments of the present disclosure.

FIG. 2 is a functional block diagram of a descriptive analysis engine in accordance with some embodiments of the present disclosure.

FIG. 3 is a flow diagram of an exemplary process for performing descriptive analysis in data mining in accordance with some embodiments of the present disclosure.

FIG. 4 is a flow diagram of a detailed exemplary process for performing descriptive analysis in data mining in accordance with some embodiments of the present disclosure.

FIG. 5 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

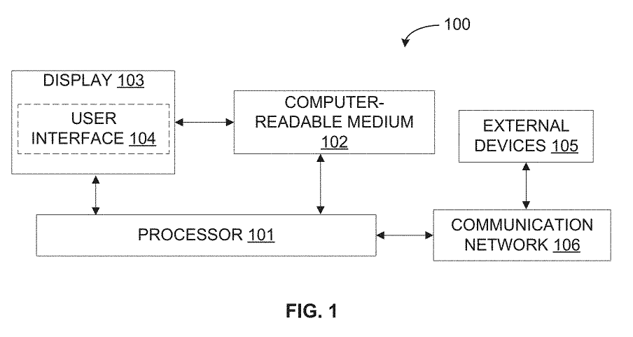

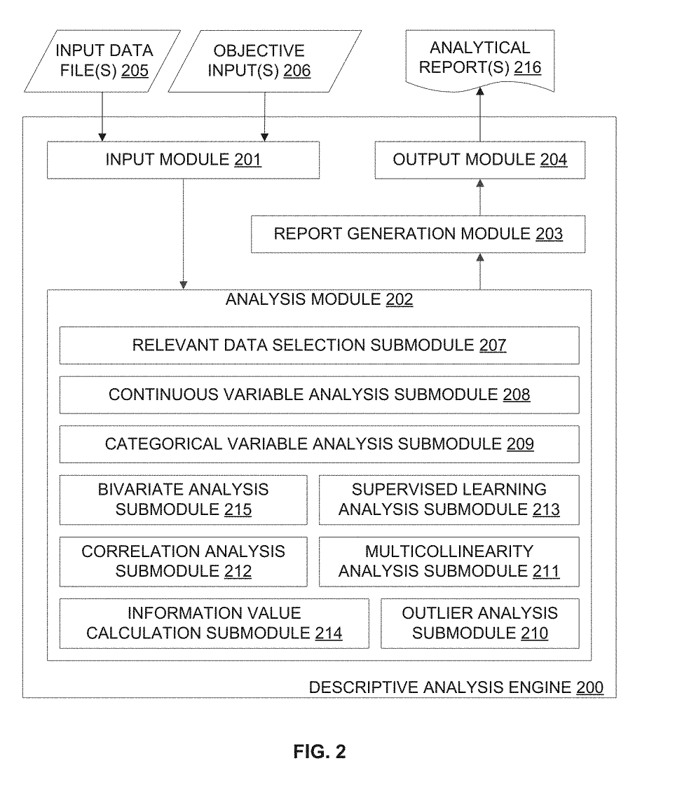

Referring now to FIG. 1, an exemplary system 100 for performing descriptive analysis in data mining is illustrated in accordance with some embodiments of the present disclosure. In particular, the system 100 (e.g., laptop, netbook, or any other computing device) implements a descriptive analysis engine for performing descriptive analysis. As will be described in greater detail in conjunction with FIG. 2, the descriptive analysis engine comprises multiple modules configured to process input data files so as to perform descriptive analysis. The descriptive analysis engine receives one or more data files comprising a plurality of data variables from one or more data sources, determines a set of data variables from the plurality of data variables based on their relevance to the descriptive analysis, identifies at least one of a set of continuous data variables and a set of categorical data variables from the set of data variables, and performs a first descriptive analysis on the set of continuous data variables and a second descriptive analysis on the set of categorical data variables.

The system 100 comprises one or more processors 101, a computer-readable medium (e.g., a memory) 102, and a display 103. The computer-readable storage medium 102 stores instructions that, when executed by the one or more processors 101, cause the one or more processors 101 to perform descriptive analysis in accordance with some embodiments of the present disclosure. For example, the computer-readable storage medium 102 may store set of instructions for receiving data files and user input, performing descriptive analyses, generating analytical reports, and rendering generated reports corresponding to input module, analysis module, report generation module, and output module respectively. The one or more processors 101 may fetch the instructions from the computer-readable storage medium 102 via a wired or wireless communication path, and execute them to perform descriptive analysis.

The computer-readable storage medium 102 may also store various data (e.g., input data files, target variables, missing records, discarded variables, continuous variables, categorical variables, various statistical evaluations of categorical variables, various statistical evaluations of continuous variables, various statistical evaluations based on target variables, analytical reports, and so forth) that may be captured, processed, and/or required by the system 100. The system 100 interacts with a user via a user interface 104 accessible via the display 103. The system 100 may also interact with one or more external devices 105 over a wired or wireless communication network 106 for sending or receiving various data. The external devices 105 may include, but are not limited to, a remote server, a digital device, or another computing system.

Referring now to FIG. 2, a functional block diagram of the descriptive analysis engine 200 implemented by the system 100 of FIG. 1 is illustrated in accordance with some embodiments of the present disclosure. The descriptive analysis engine 200 may include various modules that perform various functions so as to perform descriptive analysis. In some embodiments, the descriptive analysis engine 200 comprises an input module 201, an analysis module 202, a report generation module 203, and an output module 204.

The input module 201 receives one or more input data files 205 from one or more data sources. The one or more data sources may include, but are not limited to, a user (e.g., data analyst, marketing personnel, etc.) via the user interface, an application (e.g., Adobe Acrobat, BOT's, machine learning algorithm, MS Word, Internet Explorer, etc.), or any other connected system (e.g., enterprise resource planning (ERP) system, customer relationship management (CRM) system, any other computing system, etc.). It should be noted that, in some embodiments, the input data files 205 from different sources may be standardized prior to being fed into the descriptive analysis engine 200. Alternatively, in some embodiments, the input module 201 may standardize the input data files 205 received from different sources. In some embodiments, the input module 201 receives input data files 205 in form of a plug-in. Each of the input data files 205 comprises a plurality of data variables.

Additionally, in some embodiments, the input module 201 may receive one or more objective inputs 206 from the user, the application, or any other connected system. The objective inputs 206 may include one or more selections from an exhaustive set of exploratory statistical evaluations to be performed as a part of descriptive analysis by the descriptive analysis engine 200. The chosen set of statistical evaluations may then be used for interpretation and analysis of the data files. Additionally, the objective inputs 206 may include target variables (also referred to as dependent variables) for performing the descriptive analysis. It should be noted that the target variables are specified variables, and represents an objective for some of the statistical evaluations.

The analysis module 202 receives input data files 205 as well as objective inputs 206 (if provided) from the input module 201, and performs descriptive analysis in accordance with some embodiments of the present disclosure. In some embodiments, the analysis module 202 executes as a single function for performing a number of explanatory statistical evaluations at the descriptive stage of the data mining based on the data variables of the input data file, and the target variables (if provided). The explanatory statistical evaluations include, but are not limited to, a frequency distribution, a percentile distribution (e.g., p00 . . . p100), a missing value distribution, a mean value, a median value, a minimum value, a maximum value, and a standard deviation. Additionally, in some embodiments, if target or dependent variables are provided, the explanatory statistical evaluations include, but are not limited to, an outlier analysis, a correlation analysis, a supervised learning analysis, a bivariate analysis, an information value calculation, and a multicollinearity analysis. It should be noted that each of the explanatory statistical evaluations dependent on the target variables is performed upon the availability of corresponding target variables. In other words, only those target variable dependent statistical evaluations are performed for which corresponding target variables are provided. In some embodiments, a specialized platform may be employed for implementing the analysis module 202. For example, the specialized platform may be a statistical package R, which is an open source data mining platform.

The analysis module 202 may include a relevant data selection submodule 207, a continuous variable analysis submodule 208, a categorical variable analysis submodule 209, an outlier analysis submodule 210, a multicollinearity analysis submodule 211, a correlation analysis submodule 212, a supervised learning analysis submodule 213, an information value calculation submodule 214, and a bivariate analysis submodule 215. Thus, in some embodiments, the single function operates in form of combination of multiple subfunctions so as to perform various types of descriptive analyses.

The relevant data selection submodule 207 determines a set of data variables from the plurality of data variables that are relevant to the descriptive analysis. Thus, the relevant data selection submodule 207 discards data variables that are irrelevant for the descriptive analysis. In some embodiments, discarded variables include, but are not limited to, variables with a pre-defined threshold of records missing, variables comprising a pre-defined threshold of unique records, variables comprising a pre-defined threshold of records having same value, and categorical variables comprising a pre-defined threshold of unique attribute levels. It should be noted that the pre-defined threshold for each of the scenarios (i.e., ‘missing records’ variables, ‘unique records’ variables, ‘same value records’ variables, and ‘unique attribute levels’ categorical variables) may be provided by the user (i.e., data analyst) based on the type of data being mined. For example, the pre-defined thresholds for market insight data of a consumer durable company may be different from that for customer related data of a financial company. Thus, in some embodiments, the pre-defined thresholds for ‘missing records’ variables, ‘unique records’ variables, ‘same value records’ variables may be 100 percent. In other words, the relevant data selection submodule 207 discards variables with all records missing (i.e., null value variables), variables comprising all unique (i.e., different) records (e.g., variable comprising ‘identification number’ as records), and variables comprising all records having same value (i.e., one unique value). Additionally, in some embodiments, the pre-defined thresholds for unique attribute levels' categorical variables may be 80 percent. In other words, the relevant data selection submodule 207 discards categorical variables comprising 80 percent of attribute levels as unique. Further, in some embodiments, the relevant data selection submodule 207 assesses data variables with missing records by identifying a total number of records missing from the data variables in the input data set (i.e., input data files). The relevant data selection submodule 207 may then provide the assessment to the report generation module 203, which then renders the same to the user (e.g., data analyst).

The continuous variable analysis submodule 208 may determine if relevant data variables are continuous or not. Alternatively, in some embodiments, the relevant data variables that are determined to be non-categorical by the categorical variable analysis submodule 209 are provided as continuous data variables to the continuous variable analysis submodule 208. The continuous variable analysis submodule 208 further performs descriptive analysis on the continuous data variables. In some embodiment, the descriptive analysis on the continuous data variables comprises evaluating the continuous data variables to determine one or more statistical parameters. The statistical parameters include, but are not limited to, a mean, a median, a standard deviation, a minimum value, a maximum value, and a percentile distribution of the continuous data variables.

The categorical variable analysis submodule 209 may determine if relevant data variables are categorical or not. Alternatively, in some embodiments, the relevant data variables that are determined to be non-continuous by the continuous variable analysis submodule 208 are provided as categorical data variables to the categorical variable analysis submodule 209. The categorical variable analysis submodule 209 further performs descriptive analysis on the categorical data variables. In some embodiment, the descriptive analysis on the categorical data variables comprises evaluating the categorical data variables to determine or identify one or more statistical parameters. The statistical parameters include, but are not limited to, a number of levels of the categorical variables, levels of the categorical variables with their total number of frequency distribution, and levels of the categorical variables with their percentage of frequency distribution.

The outlier analysis submodule 210 evaluates the relevant data variables to detect outliers. In some embodiments, the outlier analysis submodule 210 performs identification of numerical variables that have outliers by plotting the box-plots. The multicollinearity analysis submodule 211 evaluates the relevant data variables to determine multicollinearity. It should be noted that multicollinearity measures the correlation among the predictor variables. Thus, in some embodiments, the multicollinearity analysis submodule 211 measures the correlation among the relevant data variables and the target variables. Additionally, in some embodiments, the multicollinearity analysis submodule 211 measures the correlation among the relevant data variables and the target variables using a variance inflation factor (VIF). The correlation analysis submodule 212 evaluates the relevant data variables to assess correlation among them. In some embodiments, the correlation analysis submodule 212 derives a correlation matrix that provides the correlations between all the pairs of relevant data variables in the input data files (i.e., input data set).

The supervised learning analysis submodule 213 evaluates the relevant data variables to identify groups of homogenous data variables. In some embodiments, the supervised learning analysis submodule 213 splits the relevant data variables (i.e., population or sample) into two or more homogenous groups (i.e., sub-populations) based on most significant splitter or differentiator in the relevant data variables. The information value calculation submodule 214 evaluates the relevant data variables to calculate one or more information values. The one or more information values provide predictive power of the explanatory variables. Thus, in some embodiments, the information value calculation submodule 214 calculates the predictive power of the relevant data variables. The bivariate analysis submodule 215 evaluates the relevant data variables to determine the bivariate plots. The bivariate plots depict the degree and pattern of relation between the predictor variables and the target variables. Thus, in some embodiments, the bivariate plots provide the degree and pattern of relation between the relevant data variables and the target variables.

The report generation module 203 generates analytical reports 216 based on the descriptive analysis performed by the analysis module 202. The analytical reports 216 include outcomes of the various descriptive analyses performed by the analysis module 202. These outcomes are also referred to as exploratory data analysis (EDA). The EDA are the basic results required for any kind of data analytics work including, but not limited to, business hypothesis testing, predictive modeling, behavioral segmentation, forecasting models, multinomial models, survival analysis, design of experiments, and trend analysis. The analytical reports 216 therefore provide initial business insights to the user and are useful to validate key numbers. Additionally, the analytical reports 216 provide a discussion framework between various stakeholders (e.g., senior management, data science manager, data analyst, etc.) for further analysis or processing. Further, in some embodiments, the analytical reports 216 includes an assessment of data variables with missing records as well as other such assessment on data variables provided by the relevant data selection submodule 207.

The report generation module 203 then provides the analytical reports 216 to the output module 204, which further renders the same to the user. In some embodiments, the output module 204 renders the analytical reports 216 in a user selected format. The user selectable formats include, but are not limited to, comma separated values (.csv) file, excel (.xls) file, text (.txt) file, rich text (.rtf) file, and document (.docx) file.

By way of example, the descriptive engine 200 receives data files with a number of records and variables (e.g., data is in the form of rows and columns) via the input module 201, performs one or more descriptive analyses on the input data set via the analysis module 202, generates an analytical report comprising of outcome of the one or more descriptive analyses via the report generation module 203, and renders the analytical report to the user via the output module 204 for further processing or analysis. As stated above, the descriptive engine 200 has an exhaustive set of descriptive analyses for the user to choose from. The chosen set of descriptive analyses may then be used for further interpretation and analysis. Additionally, as stated above, the individual submodules 208-215 of the analysis module 202 may automatically execute when their data variables and corresponding target variables are provided. Further, the run time for execution of the single function analysis module 202 may be minimal. The descriptive engine 200 may therefore enable the data analyst to come-up with an analytical report (i.e., EDA report) in a quick span of time at the descriptive stage of the data mining. The data analyst may then devote more time on the subsequent analysis or insight generation.

As will be appreciated by those skilled in the art, all such aforementioned modules and submodules may be represented as a single module or a combination of different modules. Further, as will be appreciated by those skilled in the art, each of the modules may reside, in whole or in parts, on one device or multiple devices in communication with each other.

Further, as will be appreciated by one skilled in the art, a variety of processes may be employed for performing descriptive analysis in data mining. For example, the exemplary system 100 may perform descriptive analysis by the processes discussed herein. In particular, as will be appreciated by those of ordinary skill in the art, control logic and/or automated routines for performing the techniques and steps described herein may be implemented by the system 100, either by hardware, software, or combinations of hardware and software. For example, suitable code may be accessed and executed by the one or more processors on the system 100 to perform some or all of the techniques described herein. Similarly application specific integrated circuits (ASICs) configured to perform some or all of the processes described herein may be included in the one or more processors on the system 100.

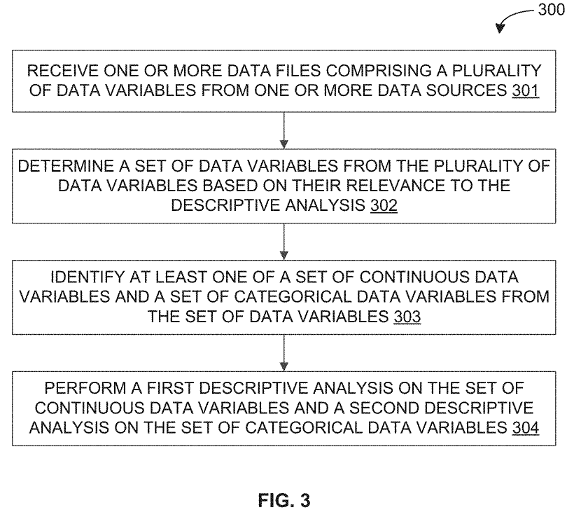

For example, referring now to FIG. 3, exemplary control logic 300 for performing descriptive analysis in data mining via a system, such as system 100, is depicted via a flowchart in accordance with some embodiments of the present disclosure. As illustrated in the flowchart, the control logic 300 includes the steps of receiving one or more data files comprising a plurality of data variables from one or more data sources at step 301, determining a set of data variables from the plurality of data variables based on their relevance to the descriptive analysis at step 302, identifying at least one of a set of continuous data variables and a set of categorical data variables from the set of data variables at step 303, and performing a first descriptive analysis on the set of continuous data variables and a second descriptive analysis on the set of categorical data variables at step 304.

In some embodiments, determining the set of data variables at step 302 comprises discarding one or more of the plurality of data variables based on their relevance to the descriptive analysis. Further, in some embodiments, the one or more variables comprises at least one of a variable with a pre-defined threshold of records missing, a variable comprising a pre-defined threshold of unique records, a variable comprising a pre-defined threshold of records having same value, and a categorical variable comprising a pre-defined threshold of unique attribute levels.

In some embodiments, the first descriptive analysis comprises evaluating the set of continuous data variables to determine at least one of a mean, a median, a standard deviation, a minimum value, a maximum value, and a percentile distribution of the set of continuous data variables. Further, in some embodiments, the second descriptive analysis comprises evaluating the set of categorical data variables to determine at least one of a number of levels of the set of categorical variables, one or more levels of the set of categorical variables with a corresponding total number of frequency distribution, and one or more levels of the set of categorical variables with a corresponding percentage of frequency distribution.

In some embodiments, the control logic 300 further includes the step of identifying a total number of records missing from the plurality of data variables. Additionally, in some embodiments, the control logic 300 further includes the steps of receiving one or more target variables from a user or a computing system, and performing a third descriptive analysis on the set of data variables based on the one or more target variables. Further, in some embodiments, the third descriptive analysis comprises evaluating the set of data variables to determine at least one of a correlation matrix, an outlier, a group of homogenous data variables, an information value, a multicollinearity, and a bivariate plot. Moreover, in some embodiments, the control logic 300 further includes the step of generating a report on the descriptive analysis in a user selected format.

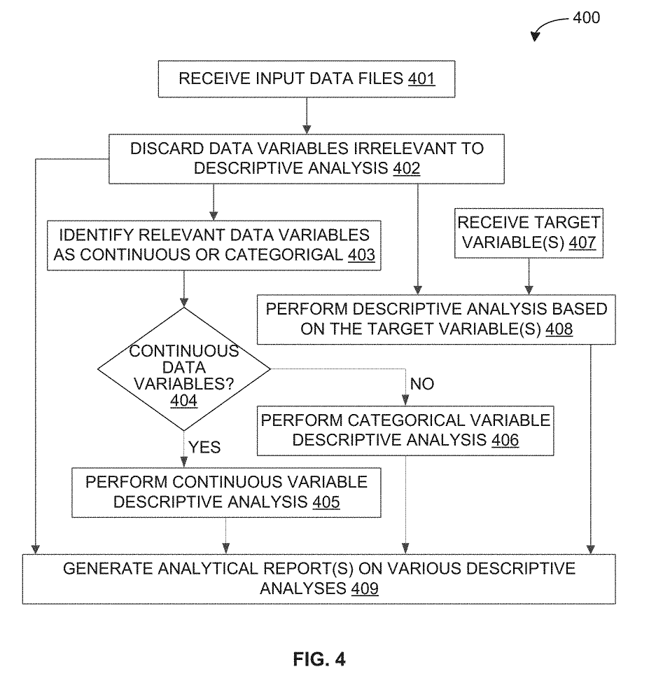

Referring now to FIG. 4, exemplary control logic 400 for performing descriptive analysis in data mining is depicted in greater detail via a flowchart in accordance with some embodiments of the present disclosure. As illustrated in the flowchart, the control logic 400 includes the step of receiving input data files comprising plurality of data variables at step 401. The control logic 400 further includes the step of discarding data variables irrelevant to the descriptive analysis at step 402. In some embodiments, the discarded variables include, but are not limited to, variables with all or mostly missing records (e.g., null value variables), variables with all different or mostly different records (e.g., variables comprising keys, variables comprising customer identifications, etc.), variables comprising records having same values, and categorical variables with all or mostly unique attribute levels. Thus, at step 402, the control logic 400 sequentially checks if each of the data variables is irrelevant to the descriptive analysis, and discards the same if found so. The remaining data variables are data variable that are relevant to the descriptive analysis.

The control logic 400 further includes the step of identifying relevant data variables as continuous or categorical at step 403. In some embodiments, identification is performed by determining if each of the relevant data variables is continuous or categorical. Thus, at step 403, the control logic 400 identifies and segregates the continuous data variables and the categorical data variables. The control logic 400 further includes the step of determining if the relevant data variables to be analyzed is continuous or categorical at step 404. For continuous data variables, the control logic 400 includes the step of performing continuous variable descriptive analysis at step 405. As stated above, the continuous variable descriptive analysis includes evaluating the continuous data variables to determine at least one of a mean, a median, a standard deviation, a minimum value, a maximum value, and a percentile distribution. Additionally, for categorical data variables, the control logic 400 includes the step of performing categorical variable descriptive analysis at step 406. Again, as stated above, the categorical variable descriptive analysis includes evaluating the categorical data variables to identify at least one of a number of levels of the categorical variables, levels of the categorical variables with their total number of frequency distribution, and levels of the categorical variables with their percentage of frequency distribution.

The control logic 400 further includes the step of receiving target variables at step 407. The target variables are specified variables with respect to which some of the statistical evaluations may be performed. The control logic 400 further includes the step of performing descriptive analysis based on the target variables at step 408. As stated above, the descriptive analysis based on the target variables includes at least one of an outlier analysis, a correlation analysis, a supervised learning analysis, a bivariate analysis, an information value calculation, and a multicollinearity analysis. It should be noted that only those target variable dependent descriptive analysis are performed for which corresponding target variables are available.

The control logic 400 further includes the step of generating analytical reports based on various descriptive analyses at step 409. Thus, at step 409, the control logic 400 generates analytical reports based on the outcomes of the descriptive analyses performed at steps 405, 406, and 408. In some embodiments, the analytical reports further include an assessment of data variables with missing records and other such assessment on data variables performed at step 402.

As will be also appreciated, the above described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

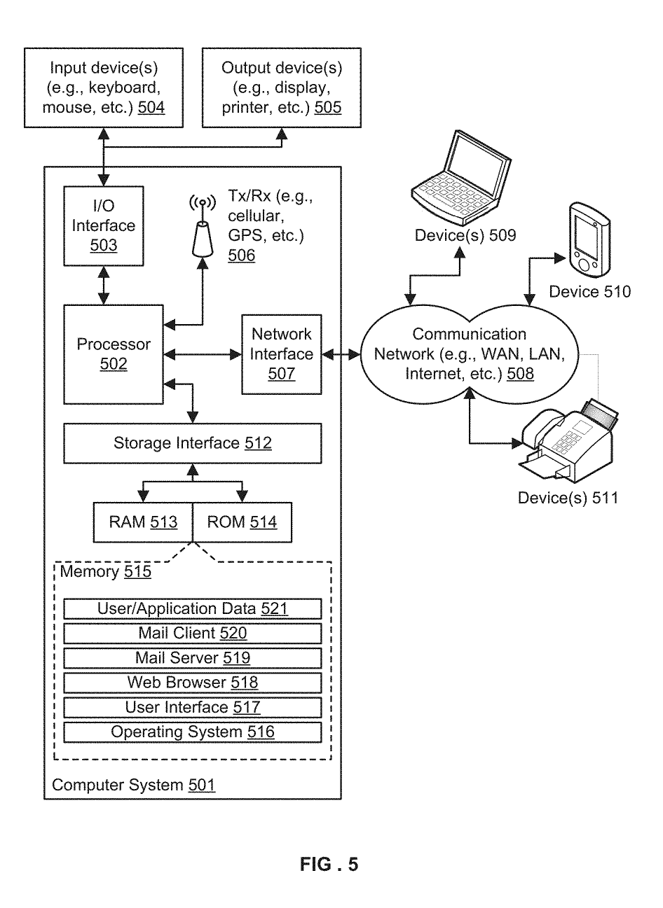

The disclosed methods and systems may be implemented on a conventional or a general-purpose computer system, such as a personal computer (PC) or server computer. Referring now to FIG. 5, a block diagram of an exemplary computer system 501 for implementing embodiments consistent with the present disclosure is illustrated. Variations of computer system 501 may be used for implementing system 100 for performing descriptive analysis in data mining. Computer system 501 may comprise a central processing unit (“CPU” or “processor”) 502. Processor 502 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 502 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 502 may be disposed in communication with one or more input/output (I/O) devices via I/O interface 503. The I/O interface 503 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 503, the computer system 501 may communicate with one or more I/O devices. For example, the input device 504 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, altimeter, gyroscope, proximity sensor, or the like), stylus, scanner, storage device, transceiver, video device/source, visors, etc. Output device 505 may be a printer, fax machine, video display (e.g., cathode ray tube (CRT), liquid crystal display (LCD), light-emitting diode (LED), plasma, or the like), audio speaker, etc. In some embodiments, a transceiver 506 may be disposed in connection with the processor 502. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 502 may be disposed in communication with a communication network 508 via a network interface 507. The network interface 507 may communicate with the communication network 508. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 508 may include, without limitation, a direct interconnection, local area network (LAN), wide area network (WAN), wireless network (e.g., using Wireless Application Protocol), the Internet, etc. Using the network interface 507 and the communication network 508, the computer system 501 may communicate with devices 509, 510, and 511. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 501 may itself embody one or more of these devices.

In some embodiments, the processor 502 may be disposed in communication with one or more memory devices (e.g., RAM 513, ROM 514, etc.) via a storage interface 512. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 516, user interface application 517, web browser 518, mail server 519, mail client 520, user/application data 521 (e.g., any data variables or data records discussed in this disclosure), etc. The operating system 516 may facilitate resource management and operation of the computer system 501. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 517 may facilitate display, execution, interaction, manipulation, or operation of program components through textual or graphical facilities. For example, user interfaces may provide computer interaction interface elements on a display system operatively connected to the computer system 501, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 501 may implement a web browser 518 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 501 may implement a mail server 519 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 501 may implement a mail client 520 stored program component. The mail client may be a mail viewing application, such as Apple Mail, Microsoft Entourage, Microsoft Outlook, Mozilla Thunderbird, etc.

In some embodiments, computer system 501 may store user/application data 521, such as the data, variables, records, etc. (e.g., input data files, target variables, missing records, discarded variables, continuous variables, categorical variables, number of levels of categorical variables, mean value, median value, standard deviation, percentile distribution, maximum value, minimum value, outliers, correlation matrix, groups of homogenous data variables, patterns, information values, bivariate plots, analytical reports, and so forth) as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

As will be appreciated by those skilled in the art, the techniques described in the various embodiments discussed above provide for robust and efficient mechanism to perform descriptive analysis in data mining. The techniques employ a single function for performing descriptive analysis and is therefore less computationally and storage intensive. Further, the techniques require less time for generating the reports as the execution of the single function is minimalistic. This provides for significant reduction in turnaround time for any data mining project, thereby enabling faster go to market solutions.

Additionally, the techniques described in the various embodiments discussed above provide for automatic descriptive analysis tool so as to evaluate exhaustive set of different explanatory statistics at the descriptive stage of data mining. The single function executes upon providing two input variables, and generates analytical reports for the user to analyze. These reports are the foundations for different kinds of further advanced analytics projects which is the real need for business, academics, research, and policy decision in today's world. Further, the accuracy of the descriptive analysis is higher as limited manual intervention is required to execute the code.

Further, the techniques described in the various embodiments discussed above is platform agnostic and may be implemented in any statistical software or platforms. As will be appreciated by those skilled in the art, the technique may be applied in a number of data mining applications such as data discovery, market analysis, customer relationship management, fraud detection, and so forth.

The specification has described system and method for performing descriptive analysis in data mining. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for performing a descriptive analysis in data mining, the method comprising:
receiving, by a descriptive analysis engine, one or more data files comprising a plurality of data variables from one or more data sources;
determining, by the descriptive analysis engine, a set of data variables from the plurality of data variables based on their relevance to the descriptive analysis;
identifying, by the descriptive analysis engine, at least one of a set of continuous data variables and a set of categorical data variables from the set of data variables; and
performing, by the descriptive analysis engine, a first descriptive analysis on the set of continuous data variables and a second descriptive analysis on the set of categorical data variables.

2. The method of claim 1, wherein determining the set of data variables comprises discarding one or more of the plurality of data variables based on their relevance to the descriptive analysis, and wherein the one or more variables comprises at least one of a variable with a pre-defined threshold of records missing, a variable comprising a pre-defined threshold of unique records, a variable comprising a pre-defined threshold of records having same value, and a categorical variable comprising a pre-defined threshold of unique attribute levels.

3. The method of claim 1, wherein the first descriptive analysis comprises evaluating the set of continuous data variables to determine at least one of a mean, a median, a standard deviation, a minimum value, a maximum value, and a percentile distribution of the set of continuous data variables.

4. The method of claim 1, wherein the second descriptive analysis comprises evaluating the set of categorical data variables to determine at least one of a number of levels of the set of categorical variables, one or more levels of the set of categorical variables with a corresponding total number of frequency distribution, and one or more levels of the set of categorical variables with a corresponding percentage of frequency distribution.

5. The method of claim 1, further comprising identifying a total number of records missing from the plurality of data variables.

6. The method of claim 1, further comprising:
receiving one or more target variables from a user or a computing system; and
performing a third descriptive analysis on the set of data variables based on the one or more target variables.

7. The method of claim 6, wherein the third descriptive analysis comprises evaluating the set of data variables to determine at least one of a correlation matrix, an outlier, a group of homogenous data variables, an information value, a multicollinearity, and a bivariate plot.

8. The method of claim 1, further comprising generating a report on the descriptive analysis in a user selected format.

9. A system for performing a descriptive analysis in data mining, the system comprising:
at least one processor; and
a memory for storing instructions that, when executed by the at least one processor, cause the at least one processor to perform operations comprising:
receiving one or more data files comprising a plurality of data variables from one or more data sources;
determining a set of data variables from the plurality of data variables based on their relevance to the descriptive analysis;
identifying at least one of a set of continuous data variables and a set of categorical data variables from the set of data variables; and
performing a first descriptive analysis on the set of continuous data variables and a second descriptive analysis on the set of categorical data variables.

10. The system of claim 9, wherein determining the set of data variables comprises discarding one or more of the plurality of data variables based on their relevance to the descriptive analysis, and wherein the one or more variables comprises at least one of a variable with a pre-defined threshold of records missing, a variable comprising a pre-defined threshold of unique records, a variable comprising a pre-defined threshold of records having same value, and a categorical variable comprising a pre-defined threshold of unique attribute levels.

11. The system of claim 9, wherein the first descriptive analysis comprises evaluating the set of continuous data variables to determine at least one of a mean, a median, a standard deviation, a minimum value, a maximum value, and a percentile distribution of the set of continuous data variables.

12. The system of claim 9, wherein the second descriptive analysis comprises evaluating the set of categorical data variables to determine at least one of a number of levels of the set of categorical variables, one or more levels of the set of categorical variables with a corresponding total number of frequency distribution, and one or more levels of the set of categorical variables with a corresponding percentage of frequency distribution.

13. The system of claim 9, wherein the operations further comprise identifying a total number of records missing from the plurality of data variables.

14. The system of claim 9, wherein the operations further comprise:
receiving one or more target variables from a user or a computing system; and
performing a third descriptive analysis on the set of data variables based on the one or more target variables.

15. The system of claim 14, wherein the third descriptive analysis comprises evaluating the set of data variables to determine at least one of a correlation matrix, an outlier, a group of homogenous data variables, an information value, a multicollinearity, and a bivariate plot.

16. The system of claim 9, wherein the operations further comprise generating a report on the descriptive analysis in a user selected format.

17. A non-transitory computer-readable medium storing instructions for performing a descriptive analysis in data mining, wherein upon execution of the instructions by one or more processors, the processors perform operations comprising:
receiving one or more data files comprising a plurality of data variables from one or more data sources;
determining a set of data variables from the plurality of data variables based on their relevance to the descriptive analysis;
identifying at least one of a set of continuous data variables and a set of categorical data variables from the set of data variables; and
performing a first descriptive analysis on the set of continuous data variables and a second descriptive analysis on the set of categorical data variables.

18. The non-transitory computer-readable medium of claim 17, wherein determining the set of data variables comprises discarding one or more of the plurality of data variables based on their relevance to the descriptive analysis, and wherein the one or more variables comprises at least one of a variable with a pre-defined threshold of records missing, a variable comprising a pre-defined threshold of unique records, a variable comprising a pre-defined threshold of records having same value, and a categorical variable comprising a pre-defined threshold of unique attribute levels.

19. The non-transitory computer-readable medium of claim 17, wherein:
the first descriptive analysis comprises evaluating the set of continuous data variables to determine at least one of a mean, a median, a standard deviation, a minimum value, a maximum value, and a percentile distribution of the set of continuous data variables; and
the second descriptive analysis comprises evaluating the set of categorical data variables to determine at least one of a number of levels of the set of categorical variables, one or more levels of the set of categorical variables with a corresponding total number of frequency distribution, and one or more levels of the set of categorical variables with a corresponding percentage of frequency distribution.

20. The non-transitory computer-readable medium of claim 17, wherein the operations further comprise:
receiving one or more target variables from a user or a computing system; and
performing a third descriptive analysis on the set of data variables based on the one or more target variables, wherein the third descriptive analysis comprises evaluating the set of data variables to determine at least one of a correlation matrix, an outlier, a group of homogenous data variables, an information value, a multicollinearity, and a bivariate plot.
